(19) United States
(12) Patent Application Publication
(10) Pub. No.: US 2014/0231401 A1
(43) Pub. Date: Aug. 21, 2014

(54) TIG Rod Feeder

(71) Applicant: Carlos David Del Rio, Glenn Heights, TX (US)

(72) Inventor: Carlos David Del Rio, Glenn Heights, TX (US)

(21) Appl. No.: 13/772,320

(22) Filed: Feb. 20, 2013

(51) Int. Cl. B23K 9/133; B23K 9/12; B23K 9/16

(52) U.S. Cl. CPC B23K 9/1336; B23K 9/164; B23K 9/122
USPC 219/137.31; 219/74

(57) ABSTRACT

It is an improved alternative device for welding, comprised of a stainless steel attachment for a cordless motorized driver, with optional extended accessory for greater adjustability. The driver includes a grooved rubber roller, whose rotation feeds a rod in a forward or backward motion, controlled by pressing the corresponding starter buttons for the driver's motor. The attachment is composed of a support ring bracket, connecting a fixed track, and adjustable track. The latter can be adjusted as desired, with the former used as support for stabilizing the rod as it is fed. The driver is designed to comfortably fit an adult hand, and power the feeding process by rotating the driver shaft, on which the rubber roller is fixed. It is an improvement for its ease of use, eliminating the restricted entry in the field, by allowing beginners to safely and efficiently weld.

### CROSS-REFERENCES TO RELATED APPLICATIONS

TIG Wire Feeder Pen—U.S. Pat. No. 5,782,394—Thomas Guinn Langley

This application claims priority to Provisional Patent Application U.S. 61/634,144 Filed on Feb. 24, 2012.

### STATEMENTS REGARDING FEDERALLY SPONSORED RESEARCH OR DEVELOPMENT

Not Applicable

### THE NAMES OF THE PARTIES TO A JOINT RESEARCH AGREEMENT

Not Applicable

### REFERENCE TO A “SEQUENCE LISTING,” A TABLE, OR A COMPUTER PROGRAM LISTING APPENDIX SUBMITTED ON A COMPACT DISC AND AN INCORPORATION-BY-REFERENCE OF THE MATERIAL ON THE COMPACT DISC (SEE 37 CFR 1.52(E)(5)). THE TOTAL NUMBER OF COMPACT DISCS INCLUDING DUPLICATES AND THE FILES ON EACH COMPACT DISC MUST BE SPECIFIED.

Not Applicable

### BACKGROUND OF THE INVENTION

Tungsten Inert Gas (hereafter TIG) welding, is the chosen method used by this invention, as it pertains to the industry in question. It has various applications, due to its compatibility with a variety of substances (e.g. aluminum, stainless steel, titanium, nickel etc) that are commonly used in the field. TIG welding has proven to be easier, safer, and more precise than alternative methods (i.e. Metal Inert Gas/Arc) to which it is comparable, and as such has become an industry standard. However, this process necessitates the steady and continuous feeding of a metallic wire or rod, a task which can prove challenging for inexperienced beginners. As the rod is being melted, it creates a pool of liquid (puddle), which is directed into a fault line of the metal that has been designated for welding. Once filled, the fault line becomes a junction, formed by the cooled metallic substance. When the gap is closed (i.e. when the metal solidifies), the process of fusion is complete. Traditionally, TIG welding has been done by hand, which requires a certain level of expertise to be possessed by the person involved. One must have sufficient skill in manipulating both the rod, and torch simultaneously. In short, the field has been, for the most part, restricted to professionals; as the finger dexterity and hand-eye coordination required to accurately feed a rod in the welding process is not easily learned. Further, the equipment used can be considered potentially harmful (when improperly handled), and costly to manufacture or replace.

### SUMMARY OF THE INVENTION

This invention will address many of the problems that have historically been incumbent to TIG welding. Its primary advantage is ease of use, in that it enables persons of lesser expertise to weld quickly, safely, and effectively. This attachment accelerates the learning process for TIG welding, and allows for more accurate results when welding ambidextrously. Moreover, persons who have less developed hand-eye coordination or welding experience, will find the hands-free adjustable structure of the rod very useful. Said attachment makes it so that, not only are the dangers of chemical skin contamination eliminated, but the user is ensured a stable and precise final product, every time. It is manufactured to be used with a highly versatile and lightweight cordless motorized driver, and is the first of its kind in the field. Although there exist comparable inventions (e.g. U.S. Pat. No. 5,782,394—TIG Wire Feeder Pen), this device is the only motorized alternative that is compatible with all TIG welding rods in the standard range of diameter.

### INDEX OF PARTS AND ACCESSORIES

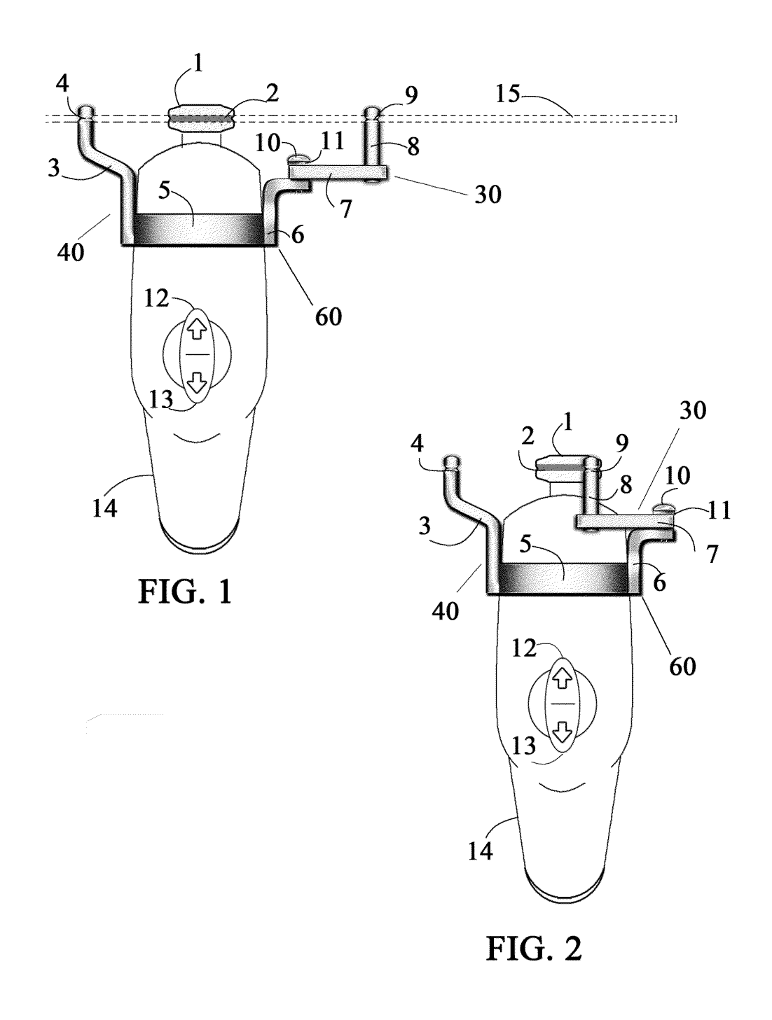

The following is an index of the pieces shown in FIGS. 1-10, as they correspond to each drawing:
1. Rubber Roller
2. Rubber Roller Groove
3. Fixed Rail
4. Fixed Rail Groove
5. Support Ring Clamp
6. Adjustable Track Support Bracket
7. Adjustable Track Arm
8. Adjustable Rail
9. Adjustable Rail Groove
10. Fastener
11. Washer
12. Forward Power Button
13. Backwards Power Button
14. Cordless Motorized Driver
15. TIG Rod
16. Extended Accessory
17. Extended Track Rail (1)
18. Extended Track Rail Groove (A)
19. Extended Track Rail (2)
20. Extended Track Rail Groove (B)
21. Entry Hole for Accessory Screw
30. Adjustable Track (7, 8, 9)
40. Fixed Track (3 & 4)
50. Extended Track Accessory (16, 17, 18, 19, 20)
60. Attachment (5, 6, 30, 40)

### DESCRIPTION OF THE DRAWINGS

Drawing 1 is composed of FIGS. 1 & 2, depicting two front views of the driver with the feeder attached.

a. FIG. 1 includes the rod, illustrated by two dotted lines, and marked as number ( 15)

b. FIG. 2 does not show the rod, and presents the adjustable track arm (7) at a angle

c. FIGS. 1 & 2 are front views of the device, from a head-on perspective

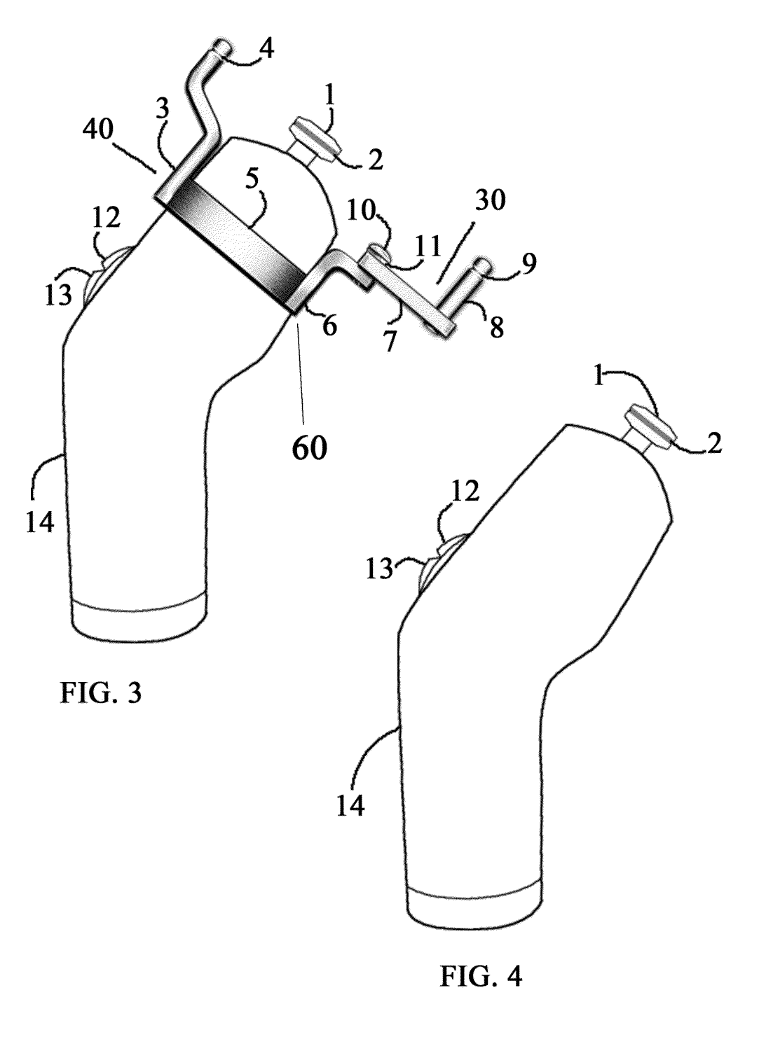

Drawing 2 is composed of FIGS. 3 & 4, both side views of the device and accessory.

a. FIG. 3 depicts one view of the driver (14) with the feeder attached

b. FIG. 4 is shown without the feeder

c. Neither is inclusive of the TIG rod (15)

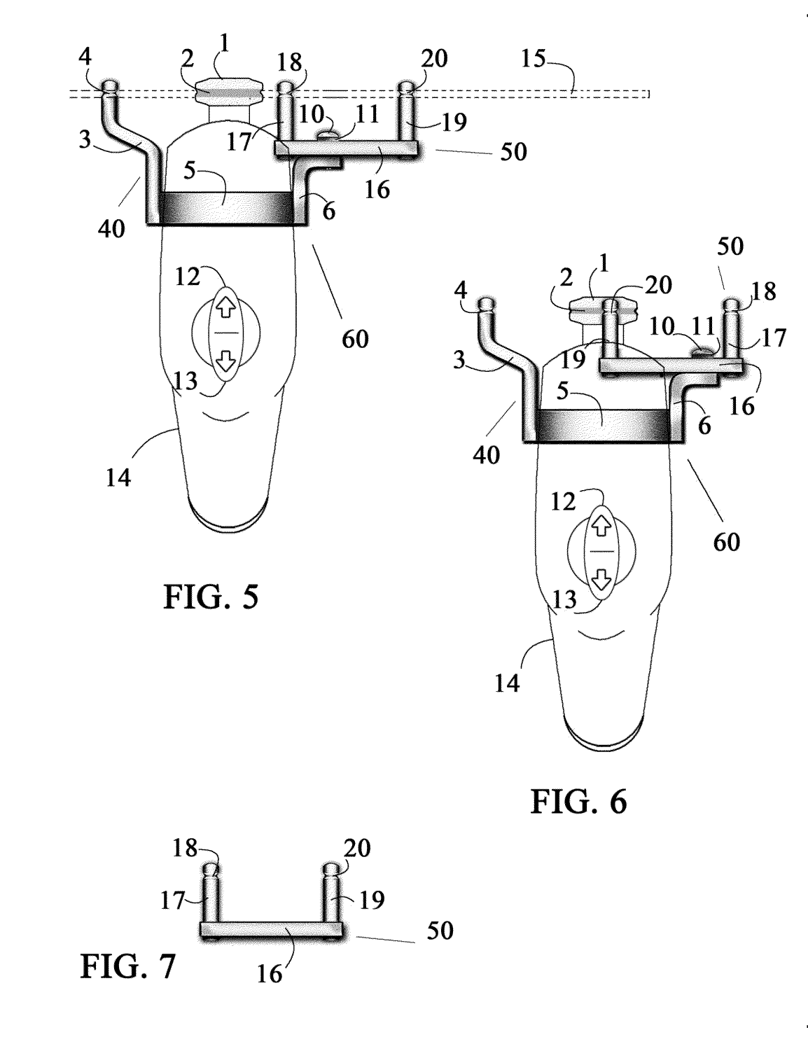

Drawing 3 is composed of FIGS. 5-7, FIGS. 5 & 6 are front views with the accessory attached, and FIG. 7 is an image of the accessory itself.

a. FIG. 5 shows the driver (14), along with the rod (15) and extended accessory (50)

b. FIG. 6 shows the adjustability of the accessory (50), by depicting it at an angle

c. FIG. 7 shows only the extended track accessory (50)

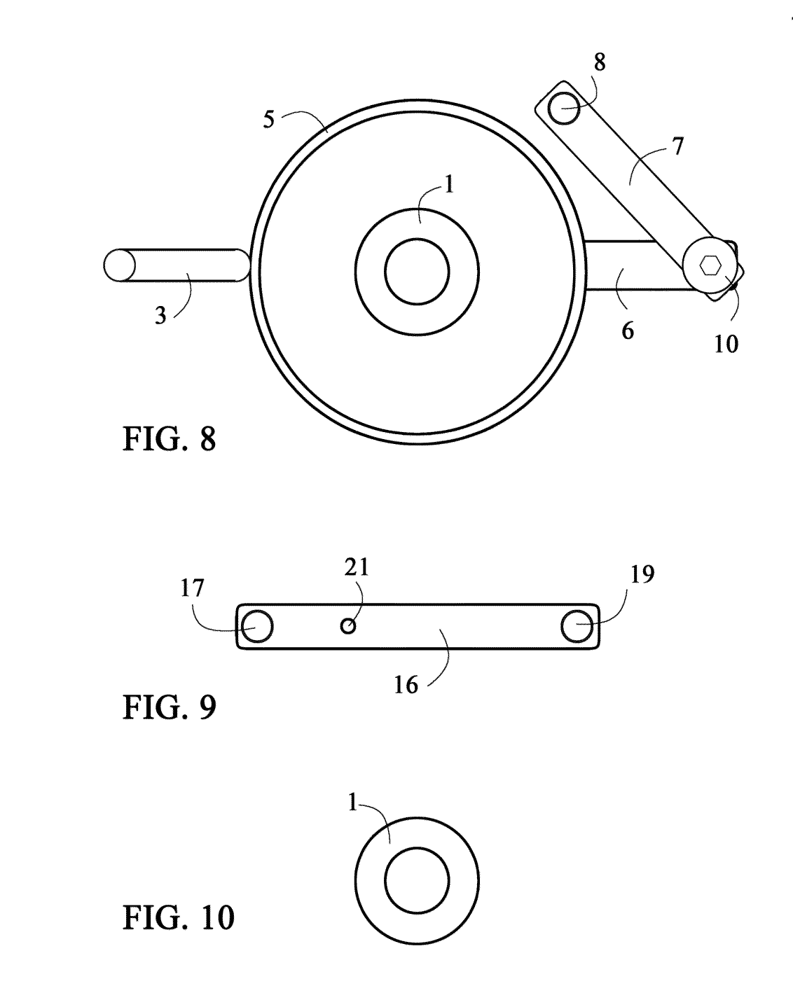

Drawing 4 is composed of FIGS. 8-10, all of which are top facing views of separate pieces

a. FIG. 8 shows the top of the attachment (60), while secured to the driver (14).

b. FIG. 9, depicts the extended track accessory (50) [also top faced view]

c. FIG. 10, is the top facing view of the rubber roller (1)

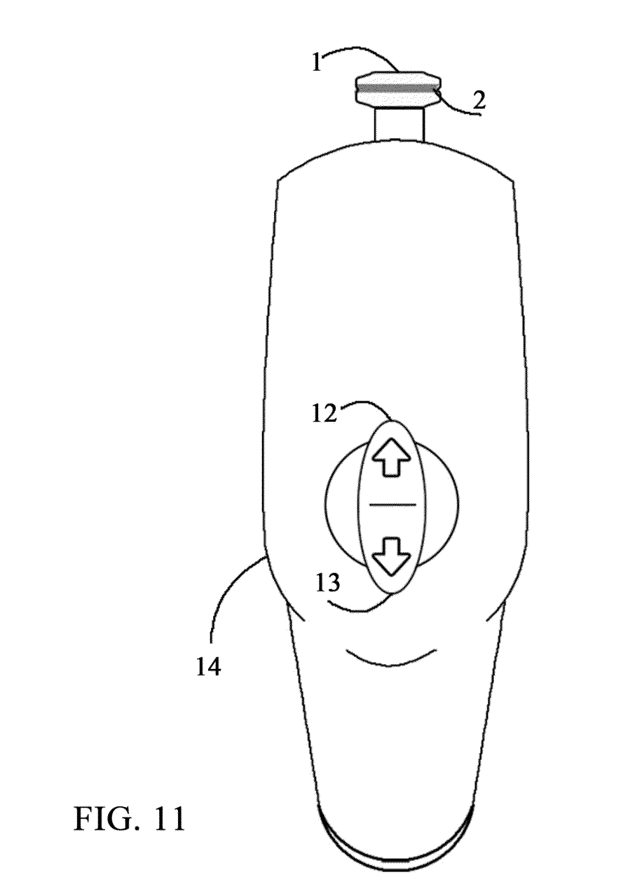

Drawing 5 is composed, only of FIG. 11. It is a front view of the driver, without any accessories.

a. It shows the rubber roller (1), and its corresponding groove (2)

b. The “up” and “down” power buttons for the motor (12 & 13)

c. The driver as a whole (14)

### DESCRIPTION OF THE INVENTION

The TIG rod feeder is designed to facilitate the use of a handheld motorized driver, by improving both efficiency and precision in function, while allowing the user to avoid physical contact with potentially hazardous welding equipment. The attachment is made entirely of stainless steel, and is fitted to a lightweight motorized driver, complete with grooved rubber roller mounted on the shaft of the driver. It is designed to provide greater adjustability of the tool, and to increase efficiency in the welding process. The attachment is assembled as follows:
1. (3) and (4) form piece (40), which is fused to part (5)
2. (7) is riveted to (8) & (9) to form piece (30)
3. (30) is then screwed to part (6) using (10) and (11)
4. Piece (6) is then fused to part (5)
5. Parts (17 & 18) and (19 & 20) are each riveted to piece (16)
6. Piece (16), along with the respective attachments above, form piece (50)
7. Piece (60) is composed of pieces (5) (6) (30) and (40)

In order to use the TIG rod feeder, one must first fix the stainless steel attachment to the top of the cordless motorized driver. The driver is a lightweight battery operated device, designed to comfortably fit an adult hand, and feed a rod (either backwards or forwards) by a grooved rubber roller which is rotated by the motor. Once locked in place, the rubber roller (1) must be placed over the motor shaft, and pressed down until flush with its front end. The support ring clamp (5) is then fixed to the motor housing, such that the bottom groove of the former, is aligned with that of the latter. (5) must be installed with the fixed track (40) pointing outwards, after which the adjustable track (6) is rotated until it is at a 90° angle relative to the tool, when pointed vertically. A welding rod is then inserted under the adjustable rail (8) into its groove (9), and slid over the corresponding groove of fixed rail (4) until approximately three inches of the rod are protruding. Then secure by placing the left thumb on the rod, such that it lies across both grooves of the rails, and that of the rubber roller. The rod is then fastened by applying pressure with the thumb, and tightening sufficiently; after which it is gradually fed forward or backward, by the rotation created by the driver (14) and rubber roller (1). This forward and backward motion can be controlled by the forward (12) and backward (13) buttons located on the driver.

I claim:

1. A battery operated handheld motorized TIG rod feeder comprising in combination:
a. A stainless steel support ring clamp for the driver, to be affixed by sliding over the motor shaft, and then locked into place
b. An adjustable track designed for providing sufficient support and appreciable mobility to the rod being fed during the course of the welding process
c. An adjustable rail with corresponding groove for securing the rod and regulating its movement throughout this process
d. An adjustable track arm to be positioned perpendicularly to the driver for optimal control in the feeding of a chosen metallic rod
e. A fastener to be tightened as needed for proper application of pressure in stabilizing the rod as it is being fed
f. A lock washer to fasten the adjustable arm in place
g. A track support bracket designed as the base to provide structure for the adjustable track
h. A rubber roller to slide atop the motor shaft, in order to house a rod (of chosen diametric measurement) while it is being automatically fed
i. A fixed track on which to rest the rod while adjusting it in the desired position
j. A fixed rail attached to the support ring clamp as a support piece for the rod

2. The aforementioned method of TIG welding, wherein the use of a stainless steel attachment is implemented to hold a rod in place, as it is being fed by a cordless motorized driver through grooves that are designed to stabilize the rod and to control the direction of its feeding

3. A handheld, cordless, and motorized driver with an attached rubber roller with forward/backward feeding capability

4. An extended track accessory, which allows for more adjustability and stability in the process
